(19) United States
(12) Patent Application Publication
(10) Pub. No.: US 2024/0314576 A1
(43) Pub. Date: Sep. 19, 2024

(54) WIRELESS COMMUNICATION SYSTEM FOR AUTOMATIC POSITIONING IN FIRST RESPONDER NETWORKS

(71) Applicant: KONINKLIJKE PHILIPS N.V., Eindhoven (NL)

(72) Inventors: Vignesh Raja Karuppiah Ramachandran, Mol (BE); Jozef Hubertus Gelissen, Herten (NL); Franciscus Antonius Maria Van De Laar, Veldhoven (NL); Walter Dees, Eindhoven (NL); Joseph Ernest Rock, Littleton, MA (US)

(21) Appl. No.: 18/276,522

(22) PCT Filed: Feb. 7, 2022
(86) PCT No.: PCT/EP2022/052843

§ 371 Date: Aug. 9, 2023

Related U.S. Application Data
(60) Provisional application No. 63/148,257, filed on Feb. 11, 2021.

(51) Int. Cl. H04W 16/18; H04W 24/08; H04W 64/00

(52) U.S. Cl. CPC H04W 16/18; H04W 24/08; H04W 64/003

(57) ABSTRACT

A first responder network is a network that is used by first responders for communicating between devices typically used by first responding officers. An MCI describes an incident in which emergency medical services are overwhelmed by the number and severity of casualties. A wireless network system is proposed which can deploy an ad-hoc first responder network to provide communication and accurate positioning services during the MCI event. The proposed system can deliver extended coverage in a constantly changing MCI area while ensuring accurate positioning of victims and triage officers in the MCI area to improve efficiency in logistics, triaging and management of clinical diagnosis.

### FIELD OF THE INVENTION

The invention relates to an establishment of a first responder network in wireless network environments, such as—but not limited to—cellular networks with indirect network connections for remote communication devices.

### BACKGROUND OF THE INVENTION

Natural disasters, such as earthquakes, hurricanes, tsunamis, rock slides, forest fires, and tropical storms can cause a great deal of damage, and can result in loss of human life. Other non-natural disasters, such as building fires, some forest fires, a building collapsing, and a terrorist attack, can similarly cause damage and loss of life. In some cases, the amount of damage and/or loss of life that results from a disaster can be reduced through improved response systems.

A mass casualty incident (MCI) describes an incident in which emergency medical services may potentially be overwhelmed by the number and severity of casualties. Triaging is a process applied when there are more casualties requiring aid than there are medical personnel available. Examples of these situations are mass-transportation accidents and terrorism.

Currently, tools that care providers use during an MCI event are relatively low tech, i.e., paper-based systems. Digital technology has been proposed to increase triage speed and have a better overview of the status of an MCI event as well as change the current static paper-based information to dynamic digital information. By doing so, logistics of clinical and non-clinical operations in an MCI event can be improved and real-time patient monitoring can be introduced by incorporating vital sign sensors.

However, the use of digital technology requires coverage for communication purposes to exchange data between mobile devices present locally on the scene either in a peer-to-peer fashion (e.g., mesh network) or in a server-client fashion (e.g., via a serving Wi-Fi access point).

One issue that often occurs during an MCI event is the overload of regular telecommunication networks. To avoid emergency medical services no longer able to communicate, countries have set up dedicated communication networks for this purpose, like FirstNet of the First Responder Network Authority in the United States and C2000 in the Netherlands. Unfortunately, it is often reported that even these networks do not work reliably.

Another issue is that during an MCI event that is caused by a perpetrator (e.g., terrorism), the perpetrator can intentionally overload and interrupt the publicly available telecommunication network. Alternatively, a natural MCI event (e.g., tsunami) can disrupt the public infrastructure of regular telecommunication networks, e.g., by damaging base stations of cellular communication network and backhaul links.

### SUMMARY OF THE INVENTION

It is an object of the present invention to enable improved service provision in MCI areas.

This object is achieved by an apparatus as claimed in claims 1 and 9, by a network controller device as claimed in claim 16, by an anchor node as claimed in claim 17, by a wireless communication system as claimed in claim 16, by a method as claimed in claims 21 and 22, and by a computer program product as claimed in claim 23.

According to a first aspect related to a network controller device end of a communication link, an apparatus is provided for establishing a wireless first responder network, wherein the apparatus is configured to:
receive information about a dimension of a target wireless coverage area;
determine a number of anchor nodes and their position in the target wireless coverage area to provide wireless coverage in the target wireless coverage area based on the capabilities of the anchor nodes; and
provide the determined position and a network configuration information to the determined anchor nodes.

It is noted that the determined position may be a geographical location (such as absolute GPS coordinates or other absolute coordinates) or a relative position or a three-dimensional absolute or relative position.

According to a second aspect related to an anchor node end of the communication link, an apparatus is provided for supporting establishment of a wireless first responder network, wherein the apparatus is configured to:
attach to the wireless first responder network;
provide wireless connectivity to wireless communication devices at an anchor node of the first responder network;
receive from a network controller device of the first responder network at least one of a position information of the anchor node, information about a target geographical area, a communication characteristic information of objects located in the target geographical area and a network configuration information;
enable wireless communication between the anchor node and one or more wireless communication devices based on the at least one of the position information, the information about the target geographical area, the communication characteristic information and the network configuration information; and
use the anchor node for enabling the one or more wireless communication devices to communicate with a core network of the first responder network or for determining position information of the one or more wireless communication devices.

The second aspect is related to anchor nodes (such as access devices that may include drones or other robotic devices), where the information about the target geographical area (e.g., best landmark location for the access device to be stationed in the target geographical area (e.g. MCI area)) may be received directly from a network controller device or via other access devices and/or a separate positioning server. It is however noted that a full-fledged communication session with the core network may not be required. In case of emergency, a simple protocol could be defined over RRC to be able to fetch the location information from a wireless communication device.

Also, the network controller device could use a 3rd party positioning application programming interface (API) to calculate this information for the access device, e.g., though a network exposure function (NEF) of the network controller device. In an example, an access device which did not receive the information about target geographical area yet could directly receive this information from a 3rd party API/NEF via other (e.g., non-3GPP) communication methods (e.g., Wi-Fi) on request of the network controller device. This is advantageous in that an access device that is far away and has lost connection to the network controller device can still be relocated to within the target geographical area.

Thus, the information about the target geographical area may be received directly from a network controller device or via other wireless communication devices, access devices, or a separate positioning server. Details needed to calculate the information about the target geographical area for the access devices (such as SLAM sensor data, signal quality information etc.) may be sent to the network controller device from the access device and wireless communication devices in the target geographical area. The geographical area may also be a three-dimensional (3D) volume. The geographical location may be an absolute coordinate (GPS position) or a relative position (e.g. with x,y,z coordinates denoting meters distance from an anchor point with coordinates (0,0)).

The information about the network configuration to setup a secure and isolated channel with wireless communication devices can be used to authorize the access device to invite wireless communication devices to a specific slice/frequency of the network in the target geographical area. The network configuration information may contain e.g. an authorization for an access device to invite wireless communication devices (e.g. by sending a dedicated signal/message, such as an SMS or Public Warning System message or a wake-up signal, which may include some digitally signed information or credentials to prove the emergency nature of the request) in the area to connect to the core network, network/slice specific settings (such as frequency, bandwidth, maximum transmit power, (minimum) desired signal quality, time synchronization data, desired quality of service (Qos), allowed devices, services offered, RLOS, steering of roaming, emergency/non-emergency slice indication), credentials (e.g. private key) needed to authorize a wireless communication device of a first responder, and an authorization to override the location privacy of wireless communication devices or to set up an emergency connection.

Pre-authorized wireless communication devices may respond to the invitation by establishing a secure channel using the credentials (e.g. public key) pre-stored in the wireless communication device, and may automatically participate in determining their position. In an example, wireless communication devices capable of proving their authenticity may be allowed to connect to the “first responder” slice. Devices not proving the authenticity may be steered to connect to a “non-first-responder” slice. Non-authenticated devices may still participate in determining their position. If these devices are invited to set up an emergency call, then according to regulatory requirements they will automatically participate in position estimation, thereby overriding any location privacy settings.

According to a third aspect related to the network controller device end of the communication link, a method of establishing a wireless first responder network is provided, wherein the method comprises:
receiving information about dimensions of a target wireless coverage area;
determining a number of anchor nodes and their position in the target wireless coverage area to provide wireless coverage in the target wireless coverage area based on capabilities of the anchor nodes; and
providing the determined position and a network configuration information to the determined anchor nodes.

According to a fourth aspect related to the anchor node end of the communication link, a method of supporting establishment of a wireless first responder network is provided, wherein the method comprises:
attaching to the wireless first responder network;
providing wireless connectivity to wireless communication devices at an anchor node of the first responder network;
receiving from a network controller device of the first responder network at least one of a position information of the anchor node, information about a target geographical area, a communication characteristic information of objects located in the target geographical area and a network configuration information;
enabling wireless communication between the anchor node and one or more wireless communication devices based on the at least one of the position information, the information about a target geographical area, the communication characteristic information and the network configuration information; and
using the anchor node for enabling the one or more wireless communication devices to communicate with a core network of the first responder network or for determining position information of the one or more wireless communication devices.

According to a fifth aspect, a network controller device for providing access to a wireless first responder network, the network controller device comprising an apparatus of the first aspect.

According to a sixth aspect, an anchor node for providing wireless connectivity to wireless communication devices in a wireless first responder network, the anchor node comprising an apparatus of the second aspect.

According to a seventh aspect, a wireless communication system is provided, comprising a network controller device of the fifth aspect, an anchor node of the sixth aspect connected to the network controller device, and one or more wireless communication devices.

Finally, according to an eighth aspect, a computer program product is provided, which comprises code means for producing the steps of the above methods of the third or fourth aspect when run on a computer device.

Accordingly, a wireless communication system for first responder networks can be provided that can achieve better accuracy in positioning casualties/victims and triage officers in an MCI field or other target geographical area and monitor their movements in real time. Furthermore, on-demand positioning accuracy, location-based grouping of devices attached to the casualties and triage officers, automatic deployment of additional resources at the infrastructure can be provided such that positioning accuracy can be maintained in a constantly changing dynamics of the environment surrounding the target geographical area. Moreover, resource utilization, infrastructure usage, and/or signal quality and/or position can be monitored and fed back to the anchor node for better coverage and positioning accuracy. Additionally, relative positioning of wireless devices can be determined either in-band (e.g. Side link PC5) or out-of-band (e.g. Wi-Fi) for accurate grouping of casualties and/or triage officers for continuous monitoring of movement of victims and/or triage officers in the field and/or for securely accessing life-critical medical information stored in devices of casualties.

According to a first option which may be combined with any of the above first to eighth aspects, the number of anchor nodes may be determined by carrying out an automatic survey of at least the target wireless coverage area to estimate at least one of a distance and presence of an object and transmission properties by ranging measurements or by reconstructing images. Thereby, the number of anchor nodes can be controlled to ensure sufficient service capacity in the target geographical area.

According to a second option which may be combined with the first option or any of the above first to eighth aspects, the determination of the geographical location of the anchor nodes may repeatedly be adapted to at least the target wireless coverage area. Thus, the coverage required for sufficient service capacity in the target geographical area can be ensured, e.g., by providing reliable and continuous positioning accuracy.

According to a third option which can be combined with the first or second option or any of the above first to eighth aspects, infrastructure usage and/or number of devices and their Qos requirements and/or signal quality and/or position accuracy may be monitored in the target wireless coverage area and anchor nodes may dynamically be added or removed based on requirements of at least the target wireless coverage area resulting from the monitoring. Thereby, the required target geographical area and/or radio parameters (e.g. bandwidth, frequency, transmit power, (minimum) desired signal quality, target QoS) can be adapted dynamically to continuously ensure sufficient service capacity in the target geographical area. In an example of the third option, the number of wireless communication devices in a certain target area may be counted and/or their position may be determined. This gives an indication of the number of casualties or more specifically casualties that are located on/near a certain tarp.

According to a fourth option which can be combined with any of the first to third options or any of the above first to eighth aspects, air-borne or land-based relay nodes may be deployed to extend coverage of the wireless signal to non-accessible areas of at least the target wireless coverage area and/or increase the positioning accuracy using extended coverage and/or additional positioning sensors.

According to a fifth option which can be combined with any of the first to fourth options or any of the above first to eighth aspects, at least one of a position of a wireless communication device, a distance between the wireless communication device and a predetermined center of a group of wireless communication devices and characteristic information about the wireless communication device and/or its user may be received by the anchor device and the wireless communication device in order to determine cluster/groups of wireless communication devices based on at least one of the relative position, the relative distance and the characteristic information.

According to a sixth option which can be combined with any of the first to fifth options or any of the above first to eighth aspects, setting of a positioning accuracy needed for the target geographical area may be enabled through an API (such as SCEF/NEF) or configuration interface (e.g. by an external application) and a set positioning accuracy may be combined with available infrastructure information of at least the target wireless coverage area to deploy additional anchor nodes or remove existing anchor nodes in the target wireless coverage area.

According to a seventh option which can be combined with any of the first to sixth options or any of the above first to eighth aspects, an additional backscatter or secure channel may be used to communicate information from the anchor node to the network controller device and/or the communication from the one or more wireless communication devices may be buffered.

According to an eighth option which can be combined with any of the first to seventh options or any of the above first to eighth aspects, a need for additional anchor nodes may be determined based on the received network configuration information and a capacity of the anchor nodes. Thereby, it can be ensured that an adequate number of anchor nodes are deployed in the target geographical area to ensure reliable and effective service provision in the target geographical area.

According to a ninth option which can be combined with any of the first to eighth options or any of the above first to eighth aspects, setting of a positioning accuracy may be enabled at the anchor node and deployment or removal of another anchor node in the target wireless coverage area may be decided based on the received network configuration information.

According to a tenth option which can be combined with any of the first to ninth options or any of the above first to eighth aspects, the anchor node may comprise an unmanned robot device that can be operated remotely or can operate autonomously and serves as a cellular access device or a relay device.

According to an eleventh option which can be combined with any of the first to tenth options or any of the above first to eighth aspects, a wireless communication device in a cluster may be identified; a position of the identified device within the cluster may be monitored to detect a movement of the identified device between different clusters and/or associate the cluster with the identified device, or at least one communication characteristic of the identified device in the cluster may be monitored to determine a change of an associated cluster of the identified device; and network resources may be allocated or deallocated depending on the location and distance of the identified device to the associated cluster. Thereby, positioning accuracy and/or quality of service can be increased.

According to a twelfth option which can be combined with any of the first to eleventh options or any of the above first to eighth aspects, an access device of another wireless network (e.g. PLMN) operating in the target geographical area may be detected and a detected access device may be requested to adapt its communication scheduling to the determination of the position of the anchor nodes or a wireless communication device or to be involved in the determination of the position of the anchor nodes or a wireless communication device, or to redirect data traffic from a wireless communication device to the first responder network. Thereby, network resources for position determination can be reduced and/or positioning accuracy can be increased.

According to a thirteenth option which can be combined with any of the first to twelfth options or any of the above first to eighth aspects, the network configuration information may comprise an authorization to override a location privacy of the one or more wireless communication devices or to set up an emergency connection.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claims 1 and 9, the network controller device of claim 16, the anchor node of claim 17, the wireless communication system of claim 19, the method of claims 21 and 22, and the computer program product of claim 23 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows an MCI scenario in which the present invention can be implemented;

FIG. 2 schematically shows an architecture of a first responder network according to various embodiments;

FIG. 3 schematically shows a block diagram of a network controller device according to various embodiments;

FIG. 4 schematically shows a block diagram of an access device according to various embodiments;

FIG. 5 schematically shows a flow diagram of a first responder network deployment procedure according to various embodiments; and

FIG. 6 schematically shows a flow diagram of a first responder network localization and mapping procedure according to various embodiments.

### DETAILED DESCRIPTION OF EMBODIMENTS

Embodiments of the present invention are now described based on a network infrastructure aimed at first responders that comprises an end-to-end wireless network that can be deployed at an MCI event or other event in which emergency personnel may require a network infrastructure to provide communication (e.g. forest fire or emergency situation in a remote area, without reliable network coverage). Even though the embodiments of the present invention are described based on a first responder network, the invention and techniques in the invention are not restricted to first responder networks and can apply to any other wireless network that needs to be deployed in areas with insufficient coverage or insufficient location estimation accuracy or any cellular Public Land Mobile Network (PLMN) or any cellular or non-cellular Non-Public Network (NPN). The network may be employed by first arriving first responders to triage and treat casualties of the MCI event. The system can be deployed on demand based on dynamics of location and specifics of the MCI event (e.g., if the MCI event is a terrorist attack, a minor or a major road accident, natural disaster, or a pandemic etc.), each of which can have their own requirements by first responders depending on the number of casualties/victims and the area surrounding the incident. Medical service vehicles, such as ambulances and fire trucks, could be outfitted with antennas for wireless communication technologies such as (but not limited to) cellular base station with direct satellite link, WIFI, Bluetooth, Long Range (LoRa) and the like.

Throughout the present disclosure, a “first responder” is meant to be a person who is among the first to arrive and provide assistance at the scene of an emergency in an MCI event, such as an accident, natural disaster, or terrorism. First responders may include law enforcement officers, paramedics, emergency medical technicians (EMT's) and firefighters. In some areas, emergency department personnel may also be required to respond to disasters and critical situations, designating them first responders. Furthermore, a “first responder network” is meant to be a network for use by first responders to support their services. A first responder network may typically be a dedicated/standalone non-public network, but may also be a network that shares infrastructure with a public network or incorporates public network functions.

Moreover, throughout the present disclosure, the terms “anchor node”, “anchor device”, “access device” and “base station” are intended to be used interchangeably.

Reasons not to use existing communication networks can be overload (typically when something happens people start using communication systems to get and spread information), unavailability of the network (especially when considering large, disastrous MCI's, such as an earthquake, plane crash in a living area or metro station, communication systems can simply be destroyed or the signal may be unable to penetrate to such locations), and unlawful intent to disrupt known and public network services by a perpetrator in a MCI event (e.g., jamming a certain radio frequency range during a terrorist attack).

As already mentioned above, there are several first responder networks such as FirstNet, which is deployed in all fifty states of the US. Although these types of first responder networks operate on a dedicated non-public radio frequency (RF) spectrum to reduce interference from the general public during an MCI event, they cannot be automatically deployed and operated independently without existing cellular infrastructure.

Alternatively, non-commercial networks such as amateur radio are frequently used during disasters. However, such networks are not very reliable for performing high bandwidth, low latency communication. Moreover, additional hardware is necessary for the user to indulge in amateur radio communication.

Furthermore, cell on wings (COW) has been proposed, in which drones are used to automatically deploy a preconfigured network infrastructure with direct satellite link. However, such COW systems are heavily pre-configured with specific network information, only suitable for areas where there is no cellular coverage and are not dynamically configurable based on specific characteristics of an MCI event.

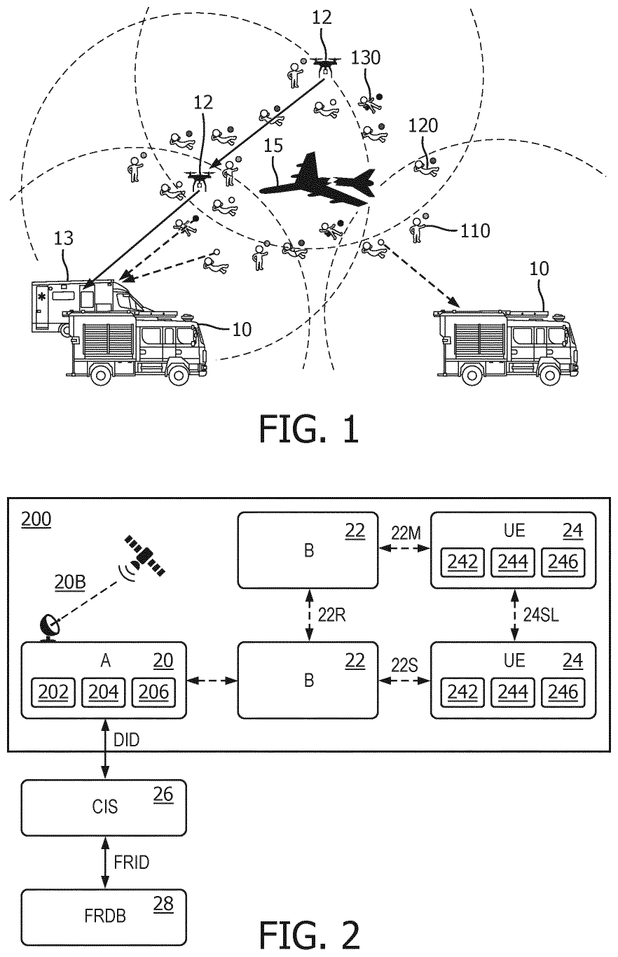

FIG. 1 schematically shows an MCI scenario in which the present invention can be implemented.

More specifically, the MCI scenario of FIG. 1 relates to a crashed airplane 15 with first responders (e.g., triage officers) 110 and triaged casualties (i.e., victims or patients) 120, 130.

In various embodiments, emergency vehicles, such as firetrucks 10 and ambulance or medical service vehicles 13, are outfitted with their own first responder network infrastructure with dedicated backhaul communication facilities (e.g., satellite antenna) that can automatically be deployed with minimal configuration to be fully operational as a stand-alone wireless first responder network that can particularly serve the MCI area. The wireless first responder network may have its own limited range to prevent interference from/to other public networks outside the MCI area.

In certain situations where the MCI event happens in a large area, the emergency vehicles 10, 13 may however be unable to provide full coverage. In FIG. 1, triaged casualties 120, 130 inside the dashed circles around the emergency vehicles 10, 13 are in the range of the two first responder networks established by the emergency vehicles 10, 13. However, the emergency vehicles 10, 13 are unable to cover the entire MCI area because they cannot reach certain places.

Other examples of non-sufficient coverage are an underground (metro) incident, an incident near or at a mountain, a swamp or a coast.

To support and/or extend the coverage area of an established first responder network, a variety of devices (e.g., wireless communication devices such as user equipment (UE) of casualties or first responders (e.g., triage officers), smart watches, cellular medical devices, etc.) that are present in the MCI area may act as relays in the first responder network.

Furthermore, the infrastructure of the wireless first responder network can be extended by adding an anchor node (e.g., access device equipped on a drone from a different first responding service) that is unknown to the deployed wireless first responder network, which can be onboarded as a part of the deployed first responder network.

Furthermore, unmanned, either remote controlled or autonomous robots such as the drones and/or motorized rovers already have wide-spread applications, such as military use, races, light shows, video and photography to deliver packages, inspecting communication lines on the bottom of the ocean and even fighting insect plagues like grasshoppers in Africa. Such unmanned robots are cost-efficient and potentially can be programmed to be either controlled remotely or entirely automated to navigate in unprecedented locations like an MCI area.

As shown in FIG. 1, drones 12 or other autonomous robots can be used to monitor and expand the MCI area of the emergency vehicle 10, 13. The network expansion can be achieved by deploying the drones 12 as relay nodes with own coverage areas (dotted circles around the drones 12). As shown in FIG. 1, the lower one of the drones 12 is located in the left coverage area of the emergency vehicles 10, 13 of FIG. 1 and is operated as a relay node of the first responder network, while the upper one of the drones 12 is located in the coverage area of the lower one (relay node) of the drones 12.

Additionally or alternatively, existing and capable cellular devices (e.g., mobile phones) or other wireless devices (not shown in FIG. 1) may be improvised and/or automatically repurposed to enhance the coverage area of the first responder network.

FIG. 2 schematically shows an architecture of a first responder network 200 according to various embodiments based on a wireless communication system (e.g., a Public Land Mobile Network (PLMN) or a Non-Public Network (NPN)).

In FIG. 2, a network controller device (device A) 20 is configured to operate a core network and may optionally be connected to other core networks of one or more mobile operators. It may comprise a network controller module or function 202, an identity service module or function 204 and a simultaneous localization and mapping (SLAM) module or function 206.

Furthermore, one or more anchor nodes, i.e., base station or access devices, (device B) 22 are connected to the device A 20 and capable of providing wireless connectivity to mobile devices 24 (devices UE) or other wireless communication devices within their coverage area. The target geographical area of the anchor nodes (device B) 22 may however be smaller than the coverage area of a single base station or access device. That is, the devices B 22 may be configured to receive information about the dimensions of a target geographical area which may be a subregion of the coverage area of one or more devices B 22 and/or may be configured to receive a desired position accuracy, and may be further configured to determine the position of a set of mobile devices UE 24 and/or may be configured to provide wireless communication between the anchor node and one or more mobile wireless devices based on the at least one of geographical location information, communication characteristic and network configuration information. Providing network access and/or position estimation may be restricted to certain groups of devices UE 24 (e.g., those operated by first responders) and/or to specific types of devices UE 24 (e.g., such with specific capabilities (e.g., side link communication or access to Global Positioning System (GPS))).

The device A 20 may be able to automatically connect to a central identity server (CIS) 26 to communicate subscriber details, such as a device identification (DID) (e.g., IMSI) of a first responder and fetch information of a user linked to a targeted device UE 24.

Additionally, a first responder database (FRDB) 28 may be provided, which can be used to pre-register at least some of the devices UE 24 to their respective first responders for verification purposes and/or to specific network slices. The device UE 24 may have a secure device identity (devID) or user identity (userID) stored in a secure memory (e.g., international mobile equipment identity (IMEI)) which is unique to the device UE 24 or to the user (e.g. digital passport) and can be coupled to a user of the device via a network related information (e.g., international mobile subscription identity (IMSI) stored in the subscriber identification module 242 (e.g., as described in GSMA SGP.21-RSP Architecture). In case of an NPN, a concept of default credentials could be used, as described in 3GPP specification TR 23.700-07.

The CIS 26 may be configured to access the first responder database 28 to derive user information (e.g., a first responder ID (FRID)) of a registered first responder associated with a device UE 24.

In an embodiment which may be combined with any other embodiment or implemented independently, the first responder network (which may be an emergency network) may be enabled to override location privacy settings (e.g. set the privacy override indicator POI as specified in 3GPP TS 23.273 5G System (5GS) Location Services (LCS)) of the device UE 24, if the device B 22 of the first responder network can prove that it is allowed to do so (e.g. by representing a PLMN operator class as specified in 3GPP TS 23.271 Functional stage 2 description of Location Services (LCS)) to the device UE 24 or the home network of the device UE 24. As an example, a device UE 24 may have a special permission set for such situations to not allow even government in all cases to have access. The device UE 24 may have stored a permission for the device or for an service/application on the device e.g. by setting an Android permission (e.g. (a not yet existing) android.permission.emergency-location or android.permission.location-override) to be enabled (e.g. which may have been enabled/approved when installing/configuring the device or a service/application, or which may have been explicitly set by the user of the device). Such permission may be linked to a password, key or other credential that may need to be provided to the device to confirm/enable/allow such permission. The user of device UE 24 may also have agreed beforehand to provide special permission by storing the consent to such special permission in the Unified Data Manager (UDM), Unified Data Repository (UDR), Home Subscriber Server (HSS) of the device UE 24's Home PLMN, which may be verified by the first responder by connecting to the respective Unified Data Manager (UDM), Unified Data Repository (UDR), Home Subscriber Server (HSS), e.g. through an NEF, or indirectly through a Public Safety Answering Point (PSAP), which may have access to the respective permission data or may have the ability to override the respective permission. In such scenario, a user or his/her friends/family (which may have been added to the information in the subscriber database (HSS), or which may have been listed as an emergency contact on the respective mobile phone's SIM card, non-volatile storage, or wearable connected to the mobile phone) may receive a notification to “unlock” the device and override location privacy indicator settings of the device or override the security lock on the device UE 24 or SIM card in order to accept an incoming invitation, connection request, position estimation request, user identification request or incoming SIM profile or authorize these actions to be taken on behalf of the casualty. Alternatively, the device A 20 of the first responder network, can provision a new location service profile (e.g. as specified in 3GPP TS 23.273 5G System (5GS) Location Services (LCS)) when establishing the network connection with one or more devices B 22 in an MCI area.

As another option, a first responder may be allowed to unlock the device UE 24 (e.g., based on a special authorization vested in the mobile device of a first responder by the network controller device A 20), after which his/her identity (e.g. subscriber concealed identity SUCI of the mobile device of the first responder) is recorded at the device UE 24 or the device A 20 to check later if this has been a legitimate action. Alternatively, the device UE 24 of the first responder can be authorized to provision (e.g. by the device 20) a new location service profile to the one or more devices UE 24 or override location privacy settings to enable ranging (i.e. estimating distance and/or angle between two devices) or to enable relative or absolute position measurement between the first responder device and the one or more device UE 24 or to enable location sharing services (e.g. by setting location privacy indicator LPI to allowed for a stipulated amount of time) of the device UE 24 (e.g. via NEF as specified by 3GPP TS 23.273 5G System (5GS) Location Services (LCS) or via secure out-of-band communication such as NFC).

Moreover, network identification/configuration information and/or connection request and/or position estimation request may include information about a cause of emergency establishment in a Master/System Information Block (MIB/SIB), RRC message, Beacon or connection request/invitation signal/message and/or position estimation request signal/message or position reference signal sent to the devices UE 24. The information may be provided in a special or dedicated information element (IE) in a preamble portion or information element of the message. The connection request/invitation may also include information about an (additional) emergency number to enable the device UE 24 to set up an (unauthenticated) emergency call upon receiving the invitation to the designated emergency number.

Moreover, devices B 22 may receive information about the network configuration to be able to set up a communication channel with mobile wireless devices and/or to estimate the positioning of mobile wireless devices from the network controller device 20. The network configuration information may comprise information to configure and/or can be used to authorize the device B to use one or more frequency bands and/or to allow mobile wireless devices to connect to a specific slice of the network in the MCI area. The network configuration information may comprise e.g. an authorization for an access device to establish a connection between mobile devices or additional access devices in the area and the core network. The network configuration information may also comprise network/slice specific settings (such as band/frequency, allowed devices, services offered, Restricted Local Operator Services (RLOS), steering of roaming, and/or emergency/non-emergency slice indication), credentials (e.g. private key) needed to authorize mobile wireless device of a first responder. The operating band/frequency that may be provided in the network configuration information may be a special emergency band for MCI events or first responder networks. It may also comprise one or more common frequency bands supported by many UEs, and/or well-known operators in the area. In order to determine if the first responder network in the MCI area is allowed to transmit in a certain frequency, the device A 20 in cooperation with devices B 22 may first scan the area for existing PLMNs operating in the area, identify their MCC/MNC code, identify a nearest base station, measure their signal strength, and may connect to those PLMNs to request permission to send an invitation signal in one or more frequency bands operated by the PLMN. If the nearest base station is very far away and/or a certain PLMN is not active in the area, or a certain band is not measured as being in use, e.g. because the base stations in the area have been destroyed or the signal is very faint, the device A 20 may provide respective frequencies as part of the network configuration information and allow/authorize access devices B 22 to use those frequency bands to send the invitation signal. Similarly, the frequency band and/or (minimum and/or maximum) bandwidth that can be used for sending a position reference signal or other signals for determining the position of devices or persons can be determined by scanning the non-used frequency bands and by requesting permission to use certain bands from a PLMN operating in the same MCI area or from a spectrum allocation server. In a particular embodiment which may be combined with any other embodiment or implemented independently, in order to reduce interference of the position reference signal or other signals for determining the position, the network controller device 20 may request/provide a PLMN operating in the same MCI area certain periods of time to do the position measurements in order for the base stations of that PLMN to take that into account into their scheduling (e.g. pause communication or request their UEs/base stations to be quiet for the requested periods of time, or to participate in determining the position (e.g. by also sending positioning signals or by providing access to a location service) and synchronize these operations).

The network controller device 20 may need to connect to the PLMN operating in the same MCI area. This may be done by the network controller device 20 detecting whether or not a nearby base station operating in the MCI area belongs to a known roaming partner PLMN, e.g. by analyzing the NR Cell Global Identity (NCGI) being broadcasted by the nearby base station, which includes information about the PLMN. If so it may connect to the respective PLMN by performing a mobile registration procedure via such nearby base station (for which it can use EAP-AKA using SIM-based credentials), or by initiating an un-authenticated emergency connection, or by setting up a disaster roaming connection as per TS 23.501, and/or by setting up a connection to the Network Exposure Function (NEF) as per TS 23.501 of the respective PLMN connection or an Service Based Interface (SIB) connection as per TS 33.501 or a connection via a Public Safety Answering Point, or a secure F1 or Xn interface connection with a RAN node of the respective PLMN as per TS 33.501, or a secure N2/NG-AP connection with an AMF as per TS 33.501, or a plug & play connection as per TS 32.508. Alternatively (e.g. if the PLMN is not a roaming partner) or additionally, in order to set up a secure connection to the respective PLMN the network controller device 20 may use pre-shared/pre-configured emergency/disaster roaming credentials or public key information about the given PLMN obtained by the network controller device 20 and use that during registration/authentication procedure with the PLMN. After or during registration to a roaming partner or non-roaming partner PLMN, the network controller device 20 may need to perform some additional authentication, authorization and verification steps, e.g. by providing/prove the possession of a special key or certificate (e.g. digitally signed by a certificate authority for emergency personnel) during registration. The network controller device 20 may use the communication channel it has set up with the PLMN (e.g. to one of its RAN nodes or a core network function of the PLMN such as AMF/NEF) and/or may during setting up a communication channel establish a secure communication interface through which it can send signals/messages to request the Radio Access Network/a base station operating in the MCI area to reduce interference by adapting their resource scheduling/operating frequencies/beams/SSB/transmit power. To this end, the network controller device 20 may provide information about its resource schedules/timing of communication and/or positioning signals, frequencies used for communication and/or positioning signals, positioning signal characteristics (e.g. transmit power, bandwidth), position signal types, timing synchronization/clock information, identity and/or position information of anchor nodes and/or wireless communication devices. Similarly, the network controller device 20 may send a signal/message to request the Radio Access Network/a base station operating in the MCI area to participate in determining the position of anchor nodes and/or wireless communication devices. To this end the network controller device 20 may provide information about its resource schedules/timing of positioning signals, frequencies used for positioning signals, positioning signal characteristics (e.g. transmit power, bandwidth), position signal types, timing synchronization/clock information, identity and/or position information of anchor nodes and/or wireless communication devices. The network controller device 20 may also request the use of a location service provided by the PLMN. The PLMN may grant such access and provide the information/credentials to use such location service, after which the network controller 20 and/or the anchor nodes and/or wireless communication devices may be instructed to connect to the respective location service. The above-mentioned requests may only be authorized if the controller device 20 has performed the additional authentication, authorization and verification steps.

In other words, the device A 20 may include or connect to an apparatus for establishing a wireless first responder network 200, wherein the apparatus may be configured to receive information about a dimension of a target wireless coverage area; determine or detect a number of anchor nodes (e.g. devices B 22) and their position in the target wireless coverage area and their capabilities; to detect an access device of another wireless network operating in the MCI or emergency area; and to request the detected access device or a RAN entity/function (e.g. RAN Centralized Unit (e.g. gNB-CU or IAB-Donor CU), or a Core Network entity/function (e.g. AMF) controlling the access device or communicating with the access device to adapt its communication scheduling to the determination of the position of the anchor nodes or a wireless communication device (e.g. device UE 24), or to be involved in the determination of the position of the anchor nodes or a wireless communication device (e.g. device UE 24).

Thus, it is proposed in an independent aspect of the invention an apparatus for establishing a wireless first responder network (200), wherein the apparatus is configured to detect an access device of another wireless network operating in the target wireless coverage area and to request a detected access device to adapt its communication scheduling to the determination of the position of anchor nodes or a wireless communication device, or to be involved in the determination of the position of the anchor nodes or a wireless communication device, or to redirect data traffic from a wireless communication device to the first responder network.

To achieve the required communication links, the devices B 22 may support single-hop relay links 22S and/or multi-hop relay links 22M to the devices UE 24 and/or base station relay links 22R among themselves.

The target geographical area could be focused on specific areas for triage (e.g., an area with most injured people, an area with less critical injuries and so on) or may be linked to a set of spatial formation requirements for identifying cluster formation (e.g., if multiple devices UE 24 are within a configurable radius around a designated relative coordinate, designated device UE 24, center of gravity, reference line, etc.). In an example, information about a potential target area (e.g. with a high concentration of potentially injured people) could be provided by one or more devices B 22, or by a separate device, e.g., via a network exposure function (NEF) and an application function (AF). In another example, a light detection and ranging (LiDAR) camera may be used to find a heat signature of mobile phones and/or people, and in this way locate (clusters of) devices or change the beamforming of one of more access device B 22 to the target the area of interest based on a heat map or signature. Furthermore, triage specific areas of victims/casualties may be identified by triage tarps with different colors (e.g., each indicating a severity level of injuries). The position (and colors) of these tarps may be determined via a camera or other color detector operated in a drone or other access device (e.g. mobile base station) or a camera on top of an ambulance or fire truck or security camera available at the scene, or may be provided by a first responder to the network (e.g., via the NEF, or directly via a data connection with the SLAM function). As an independent or additional option, the tarps could be provided with a wireless device by (possibly including a GPS module) that can register to the network to allow automatic determination of its position. In its capabilities or through matching the identity of the wireless device, the color and its size/shape/metrics/relative position of its corners can be determined. Alternatively, the tarps could be equipped with a location beacon (e.g., Bluetooth iBeacon) broadcasting its location, size, etc.

Furthermore, the tarps may be digitally recreated such that the boundaries and dimensions of the tarp are drawn with a visible optical marker (e.g. using a laser projector) in an MCI area. In situations where the tarps are fully occupied by casualties (both moving and non-moving), new casualties that are brought to the tarp are usually positioned outside the boundaries of the tarp. This may lead to confusion in determining a casualty's triage tarp, especially when the tarps are placed close to each other and that specific casualty is in the middle of the triage tarp. In such situations, a digitally drawn tarp might automatically increase or decrease its dimensions of the tarp area, by coordinating with the beacons which are placed in either the center or a recognized location in the adjacent tarps. Such coordination between the beacons of various tarps may be done without any involvement of first responders so that the tarp area is autonomously managed for increasing or decreasing number of casualties. The first responders and casualties can simply follow the newly drawn dimensions of digital tarp. Additionally, the beacon in the center of the tarp may recognize lack of space to increase the dimensions of the tarp area and request the first responder network to designate a safe space for a specific triage tarp in the MCI area. The first responder network may deploy additional beacons and designate a new tarp area upon the request for existing beacon which has recognized the lack of space in its tarp area. Any changes in the location of the tarp can be indicated to the first responders in the field and any new incoming triaged casualties can be brought to the new location of the tarp by a first responder.

In an additional embodiment which may be combined with any other embodiment or implemented independently, several devices UE 24 may be grouped into a cluster based on a triage status of a tarp, a spatial location of a device UE 24 and other properties (such as including but not limited to dimensions in horizontal and vertical planes, number of associated devices, position accuracy, location of the cluster and the device(s) in the cluster, distance from the centre of the cluster to a device UE 24) of the devices in a cluster and/or the device UE in the center of a cluster. A cluster is typically denoted by a set of devices having a set of common characteristics (e.g. communication/device/user characteristics) or that are located in a certain delimited area or are located within a certain maximum distance from each other.

The characteristics for recognizing/forming a cluster may also be a (set of) distinguishable feature(s) for a set of devices, that is not available/applicable for other devices. For example, the devices may be clustered depending on whether they are moving around (which may indicate that the injuries of a casualty carrying the device is less severe) or not moving for a certain period of time (which may indicate that the injuries of a casualty carrying the device are more severe).

Alternatively, the device A 20 of the first responder network may recognize a center of the cluster through its communication characteristics (e.g. high bandwidth, low latency, Qos requirements). Additionally, the device A 20 may detect/infer devices to belong to a certain cluster if all devices have similar communication characteristics (e.g. same QoS, similar traffic pattern, operating in the same bands or same slices or closed access groups, support the same capabilities, or are all connected to each other via D2D/sidelink communication or are operating in similar (application-controlled) group/multicast communication.

Such clusters of devices can be formed at the device A based e.g. on a triage application or network analytics function (such as NWDAF), or by the device A either via device B or via a 3rd party positioning server depending on the ranging distance between multiple UE and clusters or based on the communication characteristics of the devices in a specific cluster.

The device A, either directly or via device B, may allocate network resources (e.g. bandwidth, physical resource blocks, frequency allocation for specific time blocks) based on the properties of the cluster and/or the devices in a cluster e.g. to provide a required QoS and desired positioning accuracy for a cluster recognized/formed based on a triage status. For example, devices UE in a red tarp cluster may need high bandwidth and low latency, whereas devices UE in a green tarp cluster may only need low latency and low bandwidth, where red and green tarps indicate a high and low severity of the victims in the MCI area, respectively.

This allows the network to optimize resource allocation, e.g. allocating resources and determine the timing/schedule of these resources for wireless communication devices in a cluster or group based on their communication pattern, which may be aligned in such a way that each wireless communication device can send its data with the required data rate and within the required latency, or by assigning more resources to the center node of the cluster or group and assign separate resources for the sidelink and/or distribute the schedule information and resources over the different sidelink connections.

In other words, the device A 20 (or another device in the first responder network) may include or connect to a first apparatus for determining a cluster or group of wireless communication devices in a wireless network (e.g. first responder network 200), wherein the first apparatus may be configured to receive or learn at least one of resource usage data, position or distance measurement information, device characteristics, communication characteristics, measurement data, user characteristics of a plurality of wireless communication devices (e.g. devices UE 24); assign a minimum number of wireless communication devices for making the determination of a cluster or group of wireless communication devices; calculate at least one of:
distance between the wireless communication devices;
distance between the wireless communication devices and an anchor device (e.g. device B 22);
distance between the wireless communication devices and a target geographical area or the position of the wireless communication devices in relation to a target geographical area;
communication pattern information; and
overlap in communication characteristics, device characteristics and user characteristics;
determine a cluster or group of wireless communication devices based on at least one of:
   the calculated distance between at least the minimum number of wireless communication devices being between a minimum and maximum distance measurement threshold;
   the calculated distance between at least the minimum number of wireless communication devices and an anchor device being between a minimum and maximum distance measurement threshold;
   the calculated distance between at least the minimum number of wireless communication devices and a target geographical area being between a minimum and maximum distance measurement threshold;
   communication pattern for at least the minimum number of wireless communication devices being the same, or whereby the time variability is between a minimum and maximum time variability threshold; and
   the communication characteristics, device characteristics and user characteristics for at least the minimum number of wireless communication devices being the same for at least a minimum number of characteristics.

Furthermore, the device B 22 (or another device in the first responder network) may include or connect to a second apparatus for supporting establishment of a wireless network (e.g. first responder network 200), wherein the second apparatus is configured to provide wireless connectivity to wireless communication devices (e.g. devices UE 24) of the wireless network; receive from the first apparatus for determining a cluster or group of wireless communication devices in the wireless network, information about a set of identifiers of wireless communication devices forming a cluster or group (or at least a subset of the cluster or group of wireless communication devices for which the determined position falls within the target geographical area/coverage area), whereby the information may include (but is not limited to) device identifiers and/or positions and/or common characteristics of wireless communication devices within the cluster or group; determine a set of network resources for the cluster or group of devices; and/or allocating network resources and determine the timing/schedule of these resources based on the received information and/or by assigning more resources to a center node of the cluster or group and/or assign separate resources for the sidelink connections and/or distribute the schedule information and resources over the different sidelink connections and/or send the generated resource schedule to one of the wireless communication devices in the cluster or group for further distribution and/or invite or trigger wireless communication devices (e.g. devices UE 24) of the cluster or group of wireless communication devices to register (or de-register) via the communication channel or other communication channel to the core network operated by the network controller device (e.g. device A 20).

The above second apparatus for supporting establishment of a wireless network or the above first apparatus for determining a cluster or group of mobile devices in a wireless network may be further configured to identify a mobile wireless device (e.g. device UE 24) in a cluster or group; monitor a position of the identified device within the cluster or group to detect a movement of the identified device between different clusters or groups and/or associate the cluster or group with the identified device, or monitor at least one communication characteristic of the identified device in the cluster or group to determine a change of an associated cluster or group of the identified device; and allocate or deallocate network resources depending on the location and/or distance of the identified device to the associated cluster or group, or trigger sending of a message (e.g. through NEF, SMS) if a mobile wireless device moves beyond a configured threshold distance from the center or other device within the cluster or group and/or moves below a configured threshold distance from the center or other device of another cluster or group. It is to be noted that the monitoring and adaptation of the resources to the location can be implemented independently from the other aspects of the invention.

Alternatively or additionally, one or more of the following actions may be initiated:
trigger de-registration of the identified device from the network or slice;
trigger a handover to a different access device or to connect to a device over sidelink;
assign the device to a different cluster or group of devices;
send a different invitation message to the device;
change the QoS for the device;
change the set of allowed slices for a device; and
trigger sending of a message (e.g. through NEF, SMS) that may include a warning that a certain casualty or wireless communication device has moved to a different tarp, or outside the area (e.g. to a hospital).

These actions may also be triggered if the identified device has moved beyond a configured threshold distance from the center of a cluster or distance from another device within the cluster or a certain reference position and/or has moved below a configured threshold distance from the center or other device of another cluster or a certain reference position. The wireless mobile devices (within a cluster/group) may be configured with policy/criteria when to leave the cluster/group, e.g. a maximum distance from a center or other device in the cluster/group or particular reference coordinate, or a minimum distance from a center or other device in another cluster/group or particular reference coordinate, or a minimum/maximum signal strength/quality threshold (e.g. on sidelink), number of discoverable devices in the vicinity. If a wireless mobile finds itself in a situation that matches the conditions of the policy or pre-configured criteria, the wireless mobile device may inform the first apparatus (possibly by communicating via a second apparatus, or another wireless mobile device in the cluster or the network it connects to), that it is about to leave the cluster/group and/or about the status of the conditions and/or the measurements used for evaluating the conditions, by sending a message (e.g. to the first apparatus, second apparatus or another wireless mobile device in the cluster or to the network it connects to) indicating its intent to leave the group and/or status of the conditions (e.g. which conditions are met and which ones not) and/or the measurements used for evaluating the conditions (e.g. distance from a reference coordinate, or number of discovered devices (possibly including their identities)), upon which the first apparatus may update the cluster/group information/configuration. Alternatively or additionally the wireless mobile device may periodically send the status of the conditions or the measurements used for evaluation the conditions (e.g. distance from a reference coordinate) to the first or second apparatus which will evaluate the conditions to determine if the wireless mobile device needs to be removed from the cluster/group.

Any of the above devices and first or second apparatuses and a set of wireless communication devices (e.g. devices UE 24) may form a system, wherein the wireless communication devices send at least one of resource usage data, position or distance measurement information, device characteristics, communication characteristics, measurement data, user characteristics to the first apparatus; at least one of the first or second apparatuses determines a resource schedule by allocating resources and determining the timing/schedule of these resources for a set of wireless communication devices in a cluster or group and send the generated resource schedule and optionally information about the cluster or group to one of the wireless communication devices in the cluster or group; wherein the one wireless communication device is configured to receive the generated resource schedule and to distributing the generated resource schedule or assign resources to one or more wireless communication devices in the cluster or group based on the received resource schedule.

If current access device(s) (anchor nodes, e.g. devices B 22), in their current position, cannot achieve the QoS for the devices in a cluster or group or in a certain target geographic area, then the device A 20 may calculate a different position for already deployed access devices and instruct them to move to a new position, or may calculate a new number of access devices required to provide the desired network coverage and capacity or may free up some additional resources or open up some additional frequency bands (e.g. by reallocating resources from other wireless communication devices, clusters or groups, slices), start using unlicensed spectrum or other radio access technologies, or by requesting emergency use of additional spectrum from PLMNs in vicinity or spectrum allocation server). In an example, the device A 20 may generate an alarm (e.g. send an alarm message to one or more first responder devices), and may request additional access devices to be deployed.

Additionally, ranging between devices in a specific cluster can be continuously monitored by a device A to enable movement of devices between the clusters, such that if a casualty is moved between the tarps based on an improved or worsened medical condition, the network may automatically associate the device to a new cluster as the device moves from a one cluster to the other if it detects a change in position information, in communication characteristics of a device UE, and/or in sidelink connection to a center of the group. For example, a casualty in the MCI area may initially be placed in a yellow tarp and may eventually lose a lot of blood while being in the yellow tarp, so that he/she may automatically be categorized as a red victim after a while. A first responder may move the casualty from the yellow cluster to a red cluster given the current worsened medical condition of the casualty. The 1-hop ranging distance between the device and the center of the cluster and/or or two- or multi-hop distance to the center of the cluster may be used to determine the associated cluster of a specific device. Thus, during a transition, the cardinality of a device UE could be more than one, such that it may be associated with two or more clusters. In such a case, the device A may adapt the network resources of a device UE only after ranging measurements are constant, i.e., after the device UE has stopped moving between the cluster for a stipulated amount of time.

Furthermore, the devices UE 24 may be authorized to perform the above core network registration themselves (e.g., the core network operated by the device A 20 being part of an authorized PLMN/NPN list and/or steering of roaming information).

Alternatively, if emergency or restricted local operator services (RLOS) connections are enabled by a home PLMN of device UE 24 or are suggested/mandated by national regulations of mobile networks in the MCI area, an initial connection to the first responder network with restricted service access or emergency call maybe established with the device UE 24 (e.g., as specified under provisions for continuity of service in 3GPP TS 22.011 Service accessibility). The device A 20 may be configured with a special privilege to update PLMN selection procedure to allow roaming of the device UE 24 in the first responder network (e.g., as specified under steering of roaming information in 3GPP TS 22.011 Service accessibility). The device UE 24 may be connected to the first responder network as a roaming device after successfully completing the roaming authentication procedure (e.g. as specified under service access authorization in 3GPP TS 33.501 Security architecture and procedures for 5G system). This may be based on a special cooperation between emergency or RLOS operators and mobile operators of the devices UE 24 or a national regulation to identify, authorize and allow the device A 20 of a first responder network to establish a restricted service with a device UE 24 at an MCI location. This can be indicated in one of the network broadcast information blocks (e.g., system information block (SIB) as specified by 3GPP TS 38.331 Radio Resource Control (RRC) protocol specification) of the first responder network while sending implicit and explicit invitations to the device UE 24 at an MCI location.

As an additional option, if a device UE 24 is still connected to an existing PLMN operating in the same MCI area, the first responder network (e.g. network controller device A 20) may send a message (e.g. via data connection) via an application server (e.g. on the internet or operated by the Home PLMN) to a particular emergency application running on the device UE 24, that allows the device UE 24 to set up an emergency call (or RLOS) connection to the first responder network either directly or routed via the Home PLMN and/or provide location information to the first responder network via the Home PLMN.

The one or more devices UE 24 may comprise a subscriber identification module 242 (e.g., a universal integrated circuit card (UICC) containing a subscriber identity module (SIM) card or a Universal Mobile Telecommunications System (UMTS) SIM (USIM) card) that is associated with a mobile operator's subscription, a radio module 244 for wireless communication, and at least one user application (app) 246. The devices UE 24 may be configured to support side link communication links 24SL between themselves.

The first responder network 200 may thus be established by the devices A 20, B 22 and UE 24 (e.g., as described in 3GPP specifications as a 2G/3G/4G or 5G network, including but not limited to non-3GPP access of unlicensed wireless spectrum such as Wi-Fi, Bluetooth, industrial, scientific and medical (ISM) bands or the like). The infrastructure of the first responder network 200 may follow specifications of corresponding technology with which the network chooses to operate its devices A 20, B 22, and UE 24.

Furthermore, all devices UE 24 deployed by a first responder in the first responder network 200 can typically operate in either one of their ISM bands, whereas deployment of private mobile user devices (i.e., BYOD (“bring your own device”) user devices) in the MCI area is limited to radio technologies available on the user device.

Moreover, the first responder network 200 can be part of a non-public network (NPN) and/or operated by a PLMN in a certain area. In such cases, the devices B 22 and devices UE 24 attached to the first responder network 200 can communicate with each other without the device A.

The device UE 24 may have a secure device identity (devID) stored in a secure memory (e.g., international mobile equipment identity (IMEI)) which is unique to the device UE 24 and can be coupled to a user of the device via a network related information (e.g., international mobile subscription identity (IMSI) stored in the subscriber identification module 242 (e.g., as described in GSMA SGP.21-RSP Architecture). In case of an NPN, a concept of default credentials could be used, as described in 3GPP specification TR 23.700-07.

The proposed first responder network 200 may enable automatic identification and registration (onboarding) of pre-registered devices UE 24 (e.g., cellular devices) of first responders onto a non-public network that can be used in an MCI area from the network side (i.e., the device A 20). Furthermore, deployed devices UE 24 can be prevented from connecting to a public network during the MCI event, and unauthorized devices can be prevented from registering onto the first responder network 200. If pre-registered, the devices UE 24 may be provided with necessary configuration steering-of-roaming information and credentials beforehand to facilitate registration to the first responder network 200. This also holds for mobile wireless devices (e.g. UEs) from PLMNs or other NPNs that are roaming partners of the first responder network 200.

Additionally, the proposed first responder network 200 (e.g., device A 20) may allow (automatic) authorization and registration of additional base station devices (e.g., devices B 22) from various emergency services (e.g., fire, health and police departments) and other public and non-public network operators. A base station device can also be an IAB device (e.g., as specified by TS 38.174 Integrated access and backhaul radio transmission and reception), here the access device B 22 of the first responder network can act as a IAB donor to initiate a first radio link establishment with the IAB device (e.g., via S1/NG interface security and integrity protected by IPSec using the hardware root of trust located in the IAB device). Additionally, the IAB device can be equipped with id, private/public key pair, manufacturer certificates needed to establish a link between device B 22 (e.g., X2/Xn link) via special service (e.g. X2AP Global procedures as specified under 3GPP TS 36.423 X2 application protocol (X2AP)) in the device A 20 of the first responder network.

To this end, the network controller device A 20 and/or anchor device B 22 may be able to scan for or discover additional access devices (e.g. by scanning for SIB information, beacons, sending/receiving discovery messages (e.g. PC5 sidelink discovery messages). Alternatively, the network controller device A 20 and/or anchor device B 22 may send a broadcast message (e.g. a public warning system message) to request access devices (e.g. drones operating a base station, or vehicle mounted IAB relays) in the vicinity to be onboarded/invited to be added as additional access devices for the first responder network. In addition, the network controller device A 20 and/or anchor device B 22 may be able to pair and/or connect to such additional access device to be able to request the capabilities of the access device (e.g. number of antennas, coverage area information, operating frequencies, maximum transmit power, number of simultaneous cells covered, SSB configuration, radio capabilities (e.g. LTE or 5G NR features) such as support for location services/positioning signals, support for Centralized Unit (CU)-Distributed Unit (CU) split and the related F1 interface, support for N2 and/or S1 interface, which NG-AP and/or S1-AP protocol version) and/or its position and/or its current load, and/or enable exchange of security credentials/certificates/public keys/SIM profile to securely set up a connection between the network controller device A 20 (and/or anchor device B 22) and the additional access device to configure and control a requested/invited base station (e.g. using S1-AP, NG-AP, F1, N2 interface/protocol, or IAB interface), in order to receive network configuration information (e.g. frequencies, slices, synchronization/clock information etc.), communicate position information to which a mobile access device should move or which direction it should adjust its beamforming. If the additional access device is operated by another network operator with which it has an agreement, it may also set up a connection via the backend (e.g. through the SCEF/NEF). The network controller may need to perform some specific authentication, authorization and verification steps, e.g. by having a special key or certificate (e.g. digitally signed by a certificate authority for emergency personnel) to be able to set up an initial connection to the additional access device or to the another network.

Alternatively, the network controller device A 20 may be able to access a database of known mobile or stationary access devices, their operators, their location, their capabilities, their connection data, etc.) before inviting or setting up a connection to an additional access device.

Alternatively, the additional base station device may operate as a mobile device UE 24 or as a mobile IAB device that can perform registration to the first responder network according to regular mobile registration procedures if the device belongs to a known roaming partner network. If the device is not known and/or cannot be authenticated (e.g. because infrastructure connection to roaming partner's home PLMN is down), then the additional base station device may need to perform some additional authentication, authorization and verification steps, e.g. by having a special key or certificate (e.g. digitally signed by a certificate authority for emergency personnel) during registration, or e.g. by some out-of-band pairing mechanism (e.g. NFC). The additional base station may need to set up a secure F1 interface connection with a RAN Centralized Unit (e.g. gNB-CU or IAB-Donor CU) as per TS 33.501, or a secure Xn interface connection with another RAN node as per TS 33.501, or a secure N2/NG-AP connection with an AMF as per TS 33.501. It may also use Plug&Play operation as per TS 32.508. In case the additional base station is part/mounted to a drone, then it may need to perform authentication and connection setup according to TS 23.754.

In a particular embodiment which may be combined with any other embodiment or implemented independently, the additional access device is operated/controlled by another PLMN and also incorporates UE function (e.g. IAB-node), and which may be configured by the another PLMN with a list of disaster roaming networks which may include an identity of the first responder network and/or a policy to allow disaster roaming into any/unknown network if such network is available. This list may be prioritized and list the first responder network above other PLMNs in the list, and/or may include a condition (or configured with a policy) to check for a special flag/attribute broadcasted in a System Information (SI) message by an access device of the first responder network with a value to indicate that it requests for additional access devices. The first responder network may broadcast its support for disaster roaming (as per TS 23.501), and may include the identity of the another PLMN and may include a special flag/attribute (e.g. boolean “emergency use request”) with a value to indicate that it requests for additional access devices (in general) and/or that it requests a particular access device (e.g. by including its cell identifier, possibly in addition to an “emergency use request” attribute) to register to the first responder network. The first responder network may also need to provide e.g. a securely signed SI message (e.g. as per TR 33.809), to prove the request is genuine. The additional access device may use the broadcasted information received from the first responder network to decide to register to the first responder network. To further enable setting up the additional interfaces (e.g. F1 interface, N2 interface) between the first responder network and the additional access device, the AUSF/PCF/UDM of the first responder network may be configured to provide additional credentials and/or perform additional configuration (e.g. using the UE Configuration Update procedure or UE Parameter Update procedure as per 23.502) upon/after the additional access device registers to the first responder network. After receiving the additional credentials and/or configuration information the necessary interfaces (e.g. F1 interface, N2 interface) can be established between the additional access device and one or more of the access devices and/or the AMF of the first responder network.

Moreover, the proposed first responder network 200 (e.g., device A 20) allows automatic fetching of capabilities of base station devices and their position (e.g., devices B 22) to be registered into the first responder network 200.

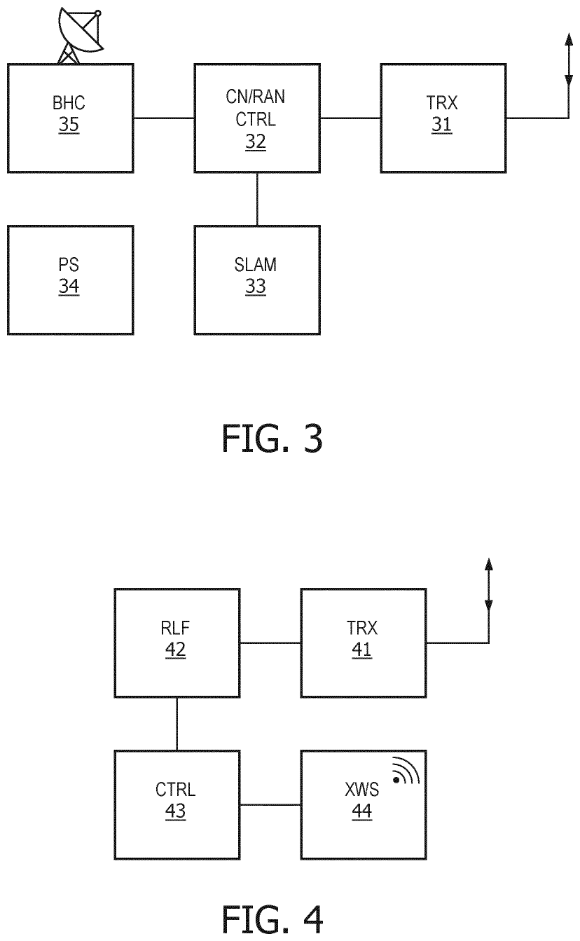

FIG. 3 schematically shows a block diagram of a network controller device (i.e., device A) according to various embodiments.

The device A may be provided on a first-arriving emergency vehicle (e.g., medical care vehicle, firetruck, unmanned aerial vehicle (UAV)) of first responders of an MCI event and may comprise a power supply (PS) unit 34 connected to an uninterrupted power supply of the emergency vehicle. It may also operate a core network (e.g. for a non-public network) and may be a base station of its own, but it can also be a backend server (e.g. placed inside an emergency vehicle. It may also be a controller unit for a set of distributed units within a base station.

The device A may further comprise a transceiver (TRX) 31 for wireless transmission and reception to/from wireless devices of the first responder network and/or may run a core network function (e.g. for a non-public network), and at least one controller (RAN CTRL) 32 that provides the network controller function 202 of FIG. 2 and that may be further configured to provide capabilities of a radio access network (RAN), e.g. operate as a base station of a cellular network, or provide a controller unit for a set of distributed units within a base station. The controller 32 may be configured to set up an integrity-protected and secure communication channel for communicatively coupling to devices B, devices UE, the central identity server, the first responder database and other services external to the described system, and to provide the identity service function 204 of FIG. 2.

Furthermore, the device A is likely to be a base station device or other network access device coupled with functionalities of a core network and may further comprise a backhaul communication module 35 that may provide a direct satellite link as a backhaul communication to enable internet access and a data path to backbone networks. Other means of backhaul communication such as optical wireless communication (OWC) may also or alternatively be deployed in the device A.

Furthermore, the device A may comprise a simultaneous localization and mapping (SLAM) module 33 (which corresponds to the SLAM function 206 of FIG. 2) with sensors and computational systems (e.g., Radar, Lidar subsystems etc.) for judging the MCI area and deciding on the number and type of devices to be deployed in the MCI area.

The device A may operate a location service (e.g. as specified in 3GPP TS 23.273) or a location management function (e.g. as specified in 3GPP TS 29.572), and may comprise a positioning module (e.g. global positioning system (GPS)), and may comprise multiple antennas (e.g. to perform beamforming), and may further support various positioning functions (e.g. Observed Time Difference of Arrival (OTDOA), Enhanced Cell ID (E-CID), RF fingerprinting, Wi-Fi Location, Bluetooth 5.1 Angle of Arrival (AoA)/Angle of Departure (AoD), position triangulation/trilateration) and the respective radio access features (such as transmitting and receiving Positioning Reference Signals (PRS)). It may also be able to connect to access devices B to cooperate in determining the position, and perform accurate synchronization amongst the access devices B, and may also be able to cooperate with base stations of PLMNs covering the same area or be able to fetch location information from location servers operated by the PLMN of a roaming partner.

In an example, an access device operated by a Public Land Mobile Network (PLMN) that operates in the same or partially overlapping area may be requested/invited (either via a signal (indicative of an emergency such as a public warning system message) transmitted by an access device B of the first responder network, or via a backend connection between the network controller device A of the first responder network and the PLMN), and subsequently authorized and registered to operate as an additional access device of the first responder network.

The device A may be able to set up a connection to the PLMN (e.g. via Service Capability Exposure Function/Network Exposure Function (SCEF/NEF) interface or Security Edge Protection Proxy (SEPP)) or set up a connection to the device B to be able to send such request/invitation for one or more base stations, and/or to request the capabilities of the device B (e.g. number of antennas, coverage area information, operating frequencies, maximum transmit power, number of simultaneous cells covered, SSB configuration, radio capabilities (e.g. LTE or 5G NR features)) and/or its position and/or its current load, and/or enable exchange of security credentials/certificates/public keys/SIM profile to securely set up a connection between the device A (and/or device B) and a requested/invited base station and/or between the device A and the PLMN, e.g. to set up a securely tunneled connection over a backend connection (e.g. via the SCEF/NEF, or SEPP) to configure and control a requested/invited base station (e.g. using S1-AP, NG-AP, F1, N2 interface/protocol, or IAB interface). To this end, the device A may need to perform some specific authentication, authorization and verification steps, e.g. by having a special key or certificate (e.g. digitally signed by a certificate authority for emergency personnel) to be able to connect to such neighboring PLMN or base station device.

FIG. 4 schematically shows a block diagram of an anchor node (i.e., device B) according to various embodiments. It may be an unmanned robot device including but not limited to drones and rovers.

The device B may comprise at least one transceiver (TRX) 31 for setting up wireless communication with wireless devices (e.g. device A or devices UE) of the first responder network and a relay functionality (RLF) 42 that provides the capabilities of a relay node (e.g., as described in 3GPP TS 24.334 V16.0.0 (2020-07): “Technical Specification Group Core Network and Terminals; Proximity-services (ProSe) User Equipment (UE) to ProSe function protocol aspects”), which can be controlled by the device A at a specific location confined to the MCI area.

Furthermore, the device B may comprise a controller (CTRL) 43 configured to provide capabilities for accessing the wireless first responder network provided by the device A. The controller 43 may further be configured to set up an integrity-protected and secure communication channel for communicatively coupling to the device A and devices UE.

Moreover, the device B may also comprise a positioning module (e.g. GPS), and may comprise multiple antennas (e.g. to perform beamforming), and may further support various positioning functions (e.g. Observed Time Difference of Arrival (OTDOA), Enhanced Cell ID (E-CID), RF fingerprinting, Wi-Fi Location, Bluetooth 5.1 Angle of Arrival (AoA)/Angle of Departure (AoD), position triangulation/trilateration) and the respective radio access features (such as transmitting and receiving Positioning Reference Signals (PRS)). It may also be able to connect to access devices B to cooperate in determining the position and/or perform accurate synchronization amongst the access devices.

In addition, the device B may also be equipped with an exclusive wireless system (XWS) 44 (e.g., Wi-Fi, Bluetooth, LoRa etc.) in addition to the radio access functions required to access the first responder network provisioned by device A. In an example, the exclusive wireless system 44 can be used for a separate sidelink communication link both from device B to device A and between devices B and to enable more accurate positioning (e.g., by sending also signals from those other radio access functions to a hybrid positioning module in a location service operated by network 200).

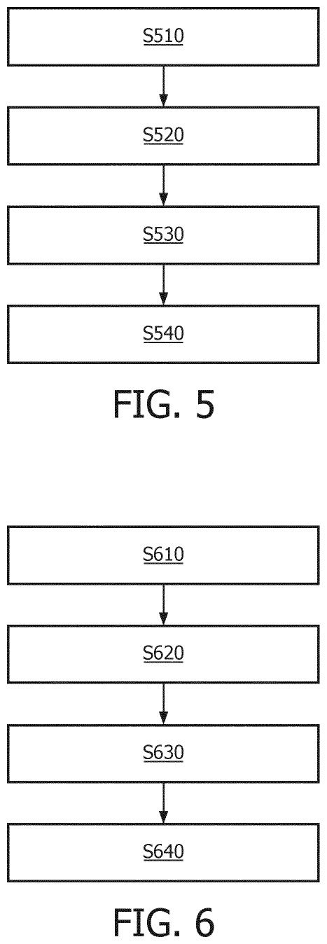

FIG. 5 schematically shows a flow diagram of a first responder network deployment procedure (e.g., at a device A) according to various embodiments.

Upon the first initiation of the device A in an MCI area, a pre-determined number of devices B (and/or other devices, such as drones dedicated to the task of mapping, that do not provide cellular access) are deployed on to the field to survey and map the MCI area and to calculate the severity and scale of the MCI area, e.g., at the SLAM module 33 of FIG. 3 (step S510). In step S520, deployed devices B, communicatively coupled to the device A via a wireless link, update their measurement parameters (for e.g. total area in square meters, structural anchor points, number of victims etc.) to a local SLAM service that is deployed either on the device A or on a cloud communicatively coupled via the device A and controlled by the SLAM function 206 of FIG. 2 or the SLAM module 33 of FIG. 3. In step S530, the SLAM service predicts a total number of devices B needed and their location in the fields to fully cover the MCI area either with or without human supervision. The procedure in step S530 may be supported by using machine learning models.

Based on the result of the SLAM service, device(s) B is/are automatically either deployed or removed from the field based on the predicted estimate of the number of first responders that are needed to attend to the particular MCI event.

More specifically, in step S530, the SLAM service may estimate landmarks in a given geographical area based on sensor measurements obtained from sensors on the device B 22 and/or other devices dedicated to the task of mapping. Landmarks may be uniquely identifiable surfaces/objects whose characteristics are estimated by sensors. For example, a concrete wall of a high raised building can be a landmark. Dimensions and refractive properties of such landmarks can be estimated by using e.g. laser scanners or other optical measuring devices present in at least some of the deployed devices B 22 and/or other devices dedicated to the task of mapping.

While determining the boundaries of the landmarks using sensors on the devices B 22 and/or the other devices dedicated to the task of mapping, the SLAM service at the device A 20 may build a virtual 3D map of the MCI area using the sensor data obtained from the sensors on the devices B 22 and/or other devices dedicated to the task of mapping.

In addition to the location and mapping measurements, a wireless radio provided on the device B 22 may simultaneously measure wireless link quality parameters (including but not limited to received signal strength, channel state information, reference signal reception power) of the radio signal between the device A 20 and the device B 22 and between the devices B 22 and the mobile devices UE 24 attached to devices B 22 covering the MCI area (and their location) in its current location. The SLAM service on device A 20 will receive this wireless link quality information from each of the devices B 22 and may also receive wireless link quality information from the mobile devices UE 24 attached to devices B 22 at a configurable sampling rate, to determine white spots of radio signal in a target geographical area.

The sensor measurements and wireless link quality parameters between the device A 20 and the devices B 22 and/or other measuring devices can be used to predict a precise location for placement of an access point (i.e. device B 22) such that a full and reliable coverage of the wireless system of the first responder network 200 can be ensured and a certain minimum positioning accuracy can be achieved. Based on this precise prediction of device B placement, the device A 20 may deploy additional access device(s) B 22 and/or relay devices to enhance coverage in white spot areas of radio links between the device A 20 and devices UE 24 in the field or to provide more accurate positioning, by allowing triangulation/trilateration from more anchor points, preferably with line of sight to the entire target area. If there are redundant devices B 22 in a location where there is good link quality, such redundant devices B 22 can be removed (e.g. retrieved from the location).

In an MCI area, surroundings can change dynamically due to the disastrous nature of the event. Big buildings can collapse into rubbles and large rubbles can fill open grounds. New metallic rubbles in open ground can change the environment both into a more favorable and less unfavorable situation for wireless communication. In such constantly changing environments, the SLAM service will receive continuous measurement parameters from sensors and wireless radio of devices B 22 and/or other devices dedicated to the task of mapping to update the SLAM service and ensure high reliability and full coverage for wireless connectivity during the entire duration of the triaging process in the MCI area.

Alternatively, the SLAM service could use an existing map (e.g. OpenStreetMap) of the target geographical area as a starting point for determining the number of devices B 22 and update the existing maps with the measurement data obtained from the devices B 22 and/or other devices dedicated to the task of mapping. Machine learning models can be used to predict both minor environmental changes (e.g. collapsed compound wall) and major environmental changes (e.g. collapsed multistorey building) based on sensor data and determine anchor points (devices B 22 and/or other devices dedicated to the task of mapping) based on the new landmarks obtained from the SLAM service.

Alternatively, when there are no large landmarks present in the MCI area (e.g., a flight crash in a grassland, where there are no buildings), wireless link quality measurements can be used as an indication or function of distance between the devices B 22 and the device A 20. In an example, sensors on the device B 22 can be used for granular distance estimation between the device A 20 and the device B 22 and wireless link quality can be mapped as a function of distance between the device A 20 and the device B 22.

Finally, in step S540, a location or positioning function or a location management function (as described above) may be applied to determine position information of one or more devices UE 24.

More specifically, the device B 22 (in cooperation with a location/positioning function or location management function) may be used to count the number of wireless communication devices in a certain target area and/or determine their current position. This can give an indication of the number of casualties in the area, or more specifically it could indicate the number of casualties that are located on/near a certain tarp. It may also be able to detect and track the movement of devices of victims or first responder personnel, which may assist in logistical purposes and make sure that no-one is lost or forgotten in the chaos of an MCI event.

The information acquired by device B 22 (in cooperation with a location/position function or location management function) may also be used to distinguish between devices that are moving (e.g. indicating that a person carrying the device may not be severely injured) and that are not moving for a prolonged period of time (e.g. indicating that a person carrying the device may be severely injured), and may at the same time distinguish first responder devices from other devices (e.g. based on their registration or capabilities), and may also identify clusters of people grouped areas (indicating e.g. victims in a certain triage area, or bystanders), and possibly excluding these devices from the set of identified moving and non-moving devices. Based on this information, the device A may deploy access devices (e.g. send additional drones or move their position) to a specific area, e.g. an area with lots of non-moving devices. Also, the number of devices that are counted may be used to request (e.g. by sending a message within a communication channel or application) a certain first responder to move to a certain area, or to request additional assistance (e.g. by requesting additional first responder personnel to get involved), and/or to determine the initial “size” of triage areas.

Furthermore, a device B 22 may be used to sense signals of devices UE 24 (e.g. mobile phones) of casualties or victims (e.g. under the rubble).

In an example, the device A receives information about the target wireless coverage area and a desired positioning accuracy and calculates the number of devices B (anchor nodes) and their 3-dimensional coordinates across a relative coordinate system covering the target wireless coverage area and configurable positioning accuracy and the space above the devices B to be deployed to provide wireless coverage throughout the entire target wireless coverage area, based on the capabilities of the devices B, and provides the 3-dimensional coordinates and network configuration information to the devices B.

The accuracy of positioning or the positioning accuracy of the first responder network 200 may in general refer to the difference between a true position of a target device and an estimated position of the device UE 24 in the horizontal or the vertical plane with respect to the device UE 24. When considering a 3-dimensional user space, the accuracy of the wireless system can be expressed in a combined horizontal and vertical plane with respect to the device UE 24. Furthermore, the precision of the positioning accuracy may refer to the resolution of the user space (e.g. an area in the horizontal plane, or the vertical plane or a combination of the horizontal and vertical planes, or a volume in a 3-dimensional cube) within which the accuracy of a wireless communication system can be achieved consistently over a statistically significant number of positioning measurements.

In an example, a first responder network with a positioning accuracy of 10 meters in the horizontal plane with a precision of 99% would mean that only one out of hundred position estimates of the device UE 24 would lie outside a 10 m radii circle, whose center is the estimated position of the device UE 24 in a horizontal plane. The real position of the device UE 24 can be anywhere within this 10 m radii circle. If the accuracy of such system is improved to 1 m, then the real position of the device UE would be anywhere within a 1 m radii circle, whose center is the estimated position of the device UE in a horizontal plane. In other words, the positioning accuracy is the closeness of the estimated value to the real value, whereas precision is the repeatability of the estimated value within a same range.

In another example, the positioning accuracy can be influenced by the elevation of a device UE in a 2-dimensional plane. For example, a device UE could be present at a distance d1 from a second device UE but elevated at an angle of 30° in the azimuth direction. For better illustration let us take the example of a clock. If the measuring device UE is located at the center of a clock with a radius of e.g. 2 m, then the distance of the minute arm is always 2 m to any minutes' position in the clock. Whereas the angle of elevation is 90° between zenith and azimuth from the center when the minute arm points at 15 minutes (3 o'clock), and the angle of elevation is approximately 30 degrees when the minute arm points at 10 minutes (2 o'clock). When representing the distance and accuracy in any positioning system, the orientation of devices in the azimuth and zenith directions and their corresponding elevation between each other in the 2-dimensional coordinates system may be considered when computing the ranging accuracy. Also, calculation of zenith and azimuth angle as a function of ranging distance may be used in the ranging and positioning system including but not limited to GPS, GNSS or Bluetooth Angle of Arrival (AoA). Any accuracy parameter expressed in terms of distance may be transformed to any coordinate system appropriately which may derive the angles of elevation in zenith and azimuth representations (e.g. celestial coordinates, polar coordinates, geographical coordinates, projected coordinates) depending on the physical properties of the devices and the measurements thereof.

In an example, the device A can be configured to provide a standalone end-to-end wireless system (e.g. cellular network comprising of hardware and software necessary for a base station, core network and a backhaul network to provide internet and a data path) either off-the-grid connection (e.g. deployed as a small cell system comprising of a non-public-network) or via the existing telecommunication grid (e.g. deployed with an existing mobile network operator (MNO) backbone).

In an example, the device A can be configured to calculate the number of devices B (anchor nodes) (e.g. including relay nodes to extend the signal from anchor nodes located in the coverage of device A) needed to be deployed for a specific MCI event by carrying out an automatic survey of the disaster area e.g. with sensor and technologies including but not limited to SLAM (simultaneous localization and mapping), radar and lidar technologies, which includes the ability to estimate the distance and presence of an object by ranging measurements and recreation of the area by reconstructing images taken with optical and RF sensors.

In an example, the device A can be configured to calculate and pre-determine the location of devices B (anchor nodes) for providing a complete coverage of the MCI area with ability to automatically adapt provide reliable and continuous positioning accuracy.

In an example, the device A can be configured to deploy devices B (anchor nodes) that include unmanned robot devices (e.g. drones) that can either be operated remotely or can operate autonomously and serves as a cellular base station or relays.

In an example, the device A can be configured to continuously monitor and feed back to the device B information about infrastructure usage, and/or signal quality and/or position accuracy and thereby dynamically add or remove devices B based on the requirements of the MCI event.

In an example, the device A can be configured the to deploy air-borne or land-based relay nodes (e.g. autonomous or remote-controlled rovers) to extend coverage of the wireless signal to the areas that are not accessible for humans e.g. locations buried deeply under the rubbles or debris from the MCI event and to increase the positioning accuracy using extended coverage and/or additional positioning sensors (e.g. RADAR, LIDAR, Infrared camera etc.).

FIG. 6 schematically shows a flow diagram of a first responder network localization and mapping procedure (e.g., at a device B) according to various embodiments.

In step S610, a device B is deployed in a target field of the MCI area based on an initial determination of the device A. Then, in step S620, the deployed device B performs measurements to derive measurement parameters (for e.g. total area in square meters, structural anchor points, number of victims etc.) in the target field of the MCI area.

Then, in step S630, the obtained or updated measurement parameters are transmitted to the device A. Furthermore, the deployed device B invites devices UE located in the target field to register to the core network operated by the device A.

In an optional step S640, the deployed device B, communicatively coupled to the device A, may be controlled by the device A to act as a relaying base station (e.g. as described in 3GPP TS 36.216 “Evolved Universal Terrestrial Radio Access (E-UTRA); Physical layer for relaying operation” or in 3GPP TS 38.174 “Integrated Access and Backhaul (IAB) radio transmission and reception”), which can relay received messages (e.g. extract data from a received signal, apply noise correction techniques and retransmit a new “clean” signal in its own coverage zone) from a device UE such that the signal coverage of device A can be extended to the entire field of the MCI area without overloading resources of the device A.

In an example, the device B (anchor node) can be configured to receive the 3-dimensional coordinates and network configuration information from the device A and to initiate wireless communication with one or more devices UE.

In an example, and in general for first responder devices, the devices B (anchor nodes) of the system can also use ambient wireless signals (e.g., from television (TV) white noise or jamming signals) to backscatter information between the anchor nodes, and between the anchor nodes and infrastructure, such that in case of unlawful disruption of wireless signals using a jammer, devices B can use the additional backscatter channel to communicate mission critical information, or that control signals can be exchanged via a secure channel in addition to the control signals transmitted and received in the conventional way, enabling energy-efficient redundancy in transmission of mission critical information of the network.

Thus, in an independent aspect of the invention, it is proposed an apparatus for supporting establishment of a wireless first responder network, wherein the apparatus is configured to use an additional backscatter or secure channel to communicate information from the anchor node to the network controller device and/or to buffer the communication from the one or more wireless communication devices.

In an example, the device B (anchor node) may be configured to automatically switch on or off its relay functionalities, e.g., by continuously monitoring the load capacity of the first responder network and optimize the network topology in coordination with device A.

In an example, relative positioning information between devices may be used to form triage groups. More specifically, a device UE of a casualty or a triage officer may communicatively couple with another device UE of a casualty or a triage officer to determine the relative position between them either via sidelink (e.g. as described in ProSe) or via any other inband or out-of-band communication. This relative position between the devices UE is either transmitted to a device A such that device A can group them based on their relative distance so that efficient tracking of color-coded triage groups can be formed and monitored by the system level. Then, a positioning accuracy can be determined by the device A for an emergency nature of a particular triage group. Alternatively, a device UE can use relative or absolute position information in addition to the triage information of the other device UE of the casualty to form a group of devices UE depending on the emergency nature of the triage group without any control from device A.

In an example, monitoring and feedback of network resources can be used to deploy additional devices B (anchor nodes) to balance network usage by devices UE. More specifically, a deployed device B acting as an anchor node in the field, continuously monitors infrastructure usage and/or signal quality and/or position accuracy of the devices UE connected to it. Based on the analysis of the monitoring information and its full capacity, the device B can determine a need for additional anchor nodes (devices B), so that the requirement of the positioning accuracy and reliability of its wireless connections can be achieved over time. The degradation caused by full exploitation of the device B's wireless resources can be efficiently minimized, by gracefully transferring a predetermined number of devices UE that are served by the device B to newly deployed anchor nodes (devices B) in the area. Alternatively, device B can communicatively couple to the device A such that the analysis of the monitoring information and decision to deploy additional anchor nodes for graceful handling of network resources can be done at the device A instead of at the device B.

In an example, the number of devices B (anchor nodes) can be calculated based on changes caused by the MCI event in the MCI area, e.g., in 911 type of events, buildings disappear and new rubble piles are formed, which can affect signal propagation. More specifically, upon deploying a device B, the device A can receive additional information about changes in the environment of the MCI area (e.g. presence, location, and dimension information of a built-up of large metal debris or a huge pile of RF conductive debris) caused by an initial MCI event or a recurring new event in the MCI area. Upon receiving this information from various devices B in the MCI area, the device A can automatically map the changes caused by the MCI event to the infrastructure of the MCI area and determine a number of devices B (anchor nodes) for a required geographical target area.

In an example, multilateration techniques (e.g. downlink observed time difference of arrival (OTDoA) as specified by 3GPP TS 37.355 “LTE Positioning Protocol (LPP)”) may be used for improving positioning accuracy in indoor and dense urban scenarios. In such a scenario, a device A may signal a positioning accuracy improvement mechanism to devices B present in the target area. Upon receiving this signal from the device A, the devices B in the target area can signal (e.g. positioning reference signal PRS as specified by 3GPP TS 38.305″ NG Radio Access Network (NG-RAN); Stage 2 functional specification of User Equipment (UE) positioning in NG-RAN″) the device UE and other anchor nodes in a target area. Upon receiving this signal, the device UE and anchor nodes can calculate the time difference in time of arrival (e.g. reference signal time difference RSTD as specified by 3GPP TS 36.133 “Evolved Universal Terrestrial Radio Access (E-UTRA); Requirements for support of radio resource management”) from a reference device B and other device B (anchor nodes), which are precisely synchronized with each other in network time. To this end, the device UE itself may calculate its position based on the time differences of arrival, assuming it has received the reference position from the anchor nodes and/or timing information to be able to do that. Alternatively, the device UE may send the measured time difference of arrival to a device B (e.g. via RSTD message) and/or via a device B to a location service operated by device A (or other device in the first responder network).

At least three time of arrival measurements are required at the device UE, i.e. a device UE has to receive a PRS signal from at least three different device B (anchor nodes) in order to achieve a 2-dimensional horizontal positioning accuracy of the device UE, because at least two equations are needed to solve two unknown parameters. For example, if a device UE receives PRS signal from three anchor nodes AN1, AN2 and AN3, with AN3 being the reference device B of a device UE, then the location coordinates of the device UE in a 2-dimensional plane, can be estimated to be at a distance DDeVUE from the reference device B using the equation from Fang's method (https://ieeexplore.ieee.org/document/102710):

$${D}_{DevUE} = [ ( \sqrt{{( {x}_{UE} - {x}_{AN 3} )}^{2} + {( {y}_{UE} - {y}_{AN 3} )}^{2}} ) / c ] - [ ( \sqrt{{( {x}_{UE} - {x}_{AN 2} )}^{2} + {( {y}_{UE} - {y}_{AN 2} )}^{2}} ) / c ] - [ ( \sqrt{{( {x}_{UE} - {x}_{AN 1} )}^{2} + {( {y}_{UE} - {y}_{AN 1} )}^{2}} ) / c ] + Δ {noise}_{( AN 3 - AN 2 - AN 1 )}$$

where, c is the speed of light and (x,y) are the 2-dimensional coordinates of the device UE and anchor nodes (AN1, AN2, AN3) from which the reference signal was received. The uncertainty in ToA measurement may be caused by including, but not limited to, the principle of dilution of precision (e.g. in geometric, horizontal or vertical planes due to the time difference or position difference of the anchor nodes) in positioning accuracy and the multipath characteristics of the wireless channel. This uncertainty maybe modelled into a noise function Δnoise, either at the device B or at device A or at a 3rd party positioning server, which can be continuously updated by various measurements in the target area of the device B, including, but not limited to the channel variations, frequency variations, multipath components, synchronization delays, RF characteristics of the environment and RF signal fluctuations caused by movements of humans, metallic object and the devices in the area. Although in theory at least three time of arrival measurements from three difference anchor nodes are sufficient for accurately solving two dimensional coordinates of a device UE, depending on the status of this noise functional model and the desired position accuracy of the target area or cluster, additional anchor nodes may be added to the target geographical area for minimalizing the measurement noise and increasing the positioning accuracy.

The noise function can be modelled in multiple ways to estimate the optimal position of anchor nodes in an MCI area for a given environmental condition and positioning accuracy.

A similar equation but in time domain is used by 3GPP in TS36.133 “Evolved Universal Terrestrial Radio Access (E-UTRA); Requirements for support of radio resource management in various sections”. The noise model may be estimated with various parameters (e.g. number of PRS, cell change in PRS, carrier specific scaling factor etc.) in different sections in the 3GPP document TS 36.133

A similar model can be extended with at least four reference signal (e.g. PRS as specified by 3GPP TS 38.305″ NG Radio Access Network (NG-RAN); Stage 2 functional specification of User Equipment (UE) positioning in NG-RAN″) measurements from four different anchor nodes for accurately solving a 3-dimensional coordinate of the device UE in the target area of a device B.

In general, the more measurements are performed and the more anchor nodes are deployed in the area, that are involved in sending the signals and are placed at strategic positions, the better the accuracy of the position gets (in particular if more devices are deployed with line-of-sight to the device for which the position needs to be determined). Also, the better the devices involved are synchronized, and the more bandwidth is used for the position reference signal, the better position accuracy can be achieved. Furthermore, the access devices could also coordinate the transmission of their position reference signals in such a way that they don't interfere with each other, that they each cover a different part of the spectrum and/or that they temporarily pause the transmission of other signals to enable the maximum bandwidth and clearest signal to be used for the position reference signals.

Similarly, an uplink observed time difference of arrival (UTDoA) could be deployed by which the devices UE are requested to transmit a sounding reference signal (SRS) or position reference signal (PRS), which can then be received by one or more access devices B that can use the measured time difference of arrival at the different access devices for determining the position of the device UE based on trilateration. Also, in this case the more access devices are deployed and are placed at strategic positions, the more accurate the position estimate will become.

In an example, a first responder can configure at the device A the position accuracy needed for the MCI area at various stages of triaging, such that the device A can combine this positioning requirement with the knowledge about the infrastructure in the MCI area to deploy or remove additional devices B (anchor nodes) in the MCI area. Alternatively, a first responder can configure position accuracy to a device B such that the decision to add or remove additional anchor nodes is made by device B confined to its current geographical target location.

Furthermore, the device B can be communicatively coupled with a device A and/or a 3rd party positioning server to calculate the positions of the anchor nodes in an MCI area based on the desired precision of accuracy or simply accuracy. For example, a desired precision of accuracy can be represented by an area within which the device UE can be truly positioned (e.g. 1 m horizontal, 3 m vertical from the real position of the device UE). An optimal precision can be achieved by having an infinitesimally small area or volume, such that the position of a device UE can be precisely represented by a point of intersection of the circles or spheres or hyperbolas drawn with a radius equal to the ranging distance between anchor nodes and the device UE. Continuous ranging measurements (e.g. signal quality as a function of distance, TDoA, and/or round-trip time calculation) will always be dynamically varying with large error margins in a MCI Area, which can reduce the precision of positioning accuracy of a device UE by the principle of geometric dilution of precision. It is known that in any ranging system (e.g. RSRP, TDoA), the location estimate is affected by the geometric dilution of precision due to persistent and large error bounds in ranging measurements. In order to compensate for the dilution of precision, a device B may continuously calculate the ratio of the position error to the range error, either directly or via device A. Absolute position (e.g. GPS, GNSS) of a reference device UE in the target area can be used to compute the position error persistent in the device B.

This ratio between position error and range error also known as the dilution of precision (e.g. in geometric, horizontal or vertical planes due to the time difference or position difference of the anchor nodes) can be used by device B to determine the confidence of positioning accuracy. An optimal positioning system would have a unitary value for this ratio. In an example, if the dilution of precision value is larger (e.g. >2) for a specific device B, then the device B either directly or via device A can adjust the position of its corresponding anchor nodes such that the area or volume within which the device UE can be truly positioned is decreased, which will increase the positioning accuracy of device UE present in the target area. Furthermore, a precise position of the device B to deliver a desired positioning accuracy both in 2-dimensional and 3-dimensional space in a target area can be estimated by using an estimator function (e.g. Kalman filter) by extrapolating the degradation of positioning accuracy as a function of geometric dilution of precision caused to the device B by adjacent anchor nodes.

In another example, a device B can either directly or via device A add (an) additional anchor node(s) in either horizontal plane, or vertical plane or both, the horizontal and vertical planes corresponding to a device UE, to decrease the area or volume within which the device UE can be positioned with increased accuracy. Alternatively, in cases where two anchor nodes are placed in a position causing destructive interference in ranging measurements, the device B can simply adjust the position of one of the anchor nodes to a new position, where errors in ranging measurement and the area or the volume within which a device UE can be positioned is decreased.

The device B can obtain the knowledge of the changes in the infrastructure of the MCI area from device A, which can be combined at the device B with the positioning accuracy configuration to add or remove additional devices B. E.g., during first 20 min of an MCI event, the positioning accuracy can be set to hundreds of meters, whereas after 1 hour of triaging, finer details of the position of the devices UE at a sub-meter range is needed, since the triage officers and casualties could be dynamically moving within small areas to search and rescue casualties in the field. Then, in the last 20 min of triage, the positioning accuracy can be set to hundreds of meters again, where triage officers will be wrapping up the triage procedure in the MCI area, with only limited number of officers on the field.

The principle of dilution of precision may be used to increase or decrease the positioning accuracy depending on including but not limited to the dynamic requirements of desired position accuracy, available resources, application preference, propagation channel, environment, wireless frequency of communication.

In an example, an authorized network controller (either an automated software function or a human) may interact with the device A (e.g. as specified in 3GPP TS 29.522: “Network Exposure Function Northbound APIs”) to manually override the network topology and alternating the relaying functionality of the device B.

To summarize, a wireless network system has been described which can deploy an ad-hoc first responder network to provide communication and accurate positioning services during the MCI event. The proposed system can deliver extended coverage in a constantly changing MCI area while ensuring accurate positioning of victims and triage officers in the MCI area to improve efficiency in logistics, triaging and management of clinical diagnosis.

For example, the location information of victim's devices can be used by a first responder to quickly split the MCI area into different triage areas, in such a way that his team members can know the location of the first responders and the victims and decide where to attend first without overlapping with the other team members.

While the invention has been illustrated and described in detail in the drawings and foregoing description, such illustration and description are to be considered illustrative or exemplary and not restrictive. The invention is not limited to the disclosed embodiments. It can be applied to various types of devices UE, such as mobile phone, vital signs monitoring/telemetry devices, smartwatches, detectors or other type of portable device.

The wireless communication devices (device UEs) can be different types of devices, e.g. mobile phones, vehicles (for vehicle-to-vehicle (V2V) communication or more general vehicle-to-everything (V2X) communication), V2X devices, IoT hubs, IoT devices, including low-power medical sensors for health monitoring, medical (emergency) diagnosis and treatment devices, for hospital use or first-responder use, virtual reality (VR) headsets, etc.

The device A may be any network access device (such as a base station, Node B (eNB, eNodeB, gNB, gNodeB, ng-eNB, etc.), access point or the like) that provides a geographical service area.

Furthermore, at least some of the above embodiments may be based on a 5G New Radio (5G NR) radio access technology. Specifically, the relay functions enable multi-hop indirect network connections for remote communication devices to achieve improved coverage for communication devices in the first responder network and improved low-power operation for IoT communication devices specifically.

Furthermore, the invention can be applied in medical applications or connected healthcare in which multiple wireless (e.g. 4G/5G) connected sensor or actuator nodes participate, in medical applications or connected healthcare in which a wireless (e.g. 4G/5G) connected equipment consumes or generates occasionally a continuous data stream of a certain average data rate, for example video, ultrasound, X-Ray, Computed Tomography (CT) imaging devices, real-time patient sensors, audio or voice or video streaming devices used by medical staff, in general IoT applications involving wireless, mobile or stationary, sensor or actuator nodes (e.g. smart city, logistics, farming, etc.), in emergency services and critical communication applications, in V2X systems, in systems for improved coverage for 5G cellular networks using high-frequency (e.g. mmWave) RF, and any other application areas of 5G communication where relaying is used.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described operations like those indicated in FIGS. 5 and 6 can be implemented as program code means of a computer program and/or as dedicated hardware of the related communication device or access device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for establishing a wireless first responder network, wherein the apparatus is configured to:
receive information about a dimension of a target wireless coverage area;
determine a number of anchor nodes and their position in the target wireless coverage area to provide wireless coverage in the target wireless coverage area based on the capabilities of the anchor nodes; and
provide the determined position and a network configuration information to the determined anchor nodes.

2. The apparatus of claim 1, further configured to determine the number of anchor nodes by carrying out an automatic survey of at least the target wireless coverage area to estimate at least one of a distance and presence of an object and transmission properties by ranging measurements or by reconstructing images.

3. The apparatus of claim 1, further configured to repeatedly adapt the determination of the geographical location of the anchor nodes to at least the target wireless coverage area.

4. The apparatus of claim 1, further configured to monitor infrastructure usage and/or number of devices and their quality of service requirements and/or signal quality and/or position accuracy in the target wireless coverage area and dynamically add or remove anchor nodes based on requirements of at least the target wireless coverage area resulting from the monitoring.

5. The apparatus of claim 1, further configured to deploy air-borne or land-based relay nodes to extend coverage of the wireless signal to non-accessible areas of at least the target wireless coverage area and/or increase the positioning accuracy using extended coverage and/or using additional positioning sensors based on the determined number of anchor nodes or their position.

6. The apparatus of claim 1, further configured to count the number of wireless communication devices in a certain target area and/or determine their position.

7. The apparatus of claim 1, further configured to enable setting of a positioning accuracy needed for the target wireless coverage area through an application programming interface or a configuration interface and to combine a set positioning accuracy with available infrastructure information of at least the target wireless coverage area to change the position of anchor nodes or to deploy additional anchor nodes or remove existing anchor nodes in the target wireless coverage area.

8. The apparatus of claim 1, further configured to detect an access device of another wireless network operating in the target wireless coverage area and to request a detected access device to adapt its communication scheduling to the determination of the position of the anchor nodes or a wireless communication device, or to be involved in the determination of the position of the anchor nodes or a wireless communication device, or to redirect data traffic from a wireless communication device to the first responder network.

9. An apparatus for supporting establishment of a wireless first responder network, wherein the apparatus is configured to:
attach to the wireless first responder network:
provide wireless connectivity to wireless communication devices at an anchor node of the first responder network;
receive from a network controller device of the first responder network at least one of a position information of the anchor node, information about a target geographical area, a communication characteristic information of objects located in target geographical area, and a network configuration information;
enable wireless communication between the anchor node and one or more wireless communication devices based on the at least one of the position information, the information about a target geographical area, the communication characteristic information and the network configuration information; and
use the anchor node for enabling the one or more wireless communication devices to communicate with a core network of the first responder network or for determining position information of the one or more wireless communication devices.

10. The apparatus of claim 9, wherein the apparatus is configured to use an additional backscatter or secure channel to communicate information from the anchor node to the network controller device and/or to buffer the communication from the one or more wireless communication devices.

11. The apparatus of claim 1, wherein the apparatus is configured to determine a need for additional anchor nodes based on the received network configuration information and a capacity of the anchor nodes.

12. The apparatus of claim 1, further configured to enable setting of a positioning accuracy at the anchor node and to decide on a deployment or removal of another anchor node in the target wireless coverage area based on the received network configuration information.

13. The apparatus of claim 1, further configured to receive at least one of a position of a wireless communication device, a distance between the wireless communication device and a predetermined center of a group of wireless communication devices and characteristic information about the wireless communication device and/or its user by the anchor node in order to determine a cluster or group of wireless communication devices based on at least one of the position, the distance and the characteristic information.

14. The apparatus of claim 13, further configured to:
identify a wireless communication device in the determined cluster;
monitor a position of the identified device within the cluster to detect a movement of the identified device between different clusters and/or associate the cluster with the identified device, or monitor at least one communication characteristic of the identified device in the cluster to determine a change of an associated cluster of the identified device; and
allocate or deallocate network resources depending on the location and/or distance of the identified device to the associated cluster.

15. The apparatus of claim 9, wherein the network configuration information comprises an authorization to override a location privacy of the one or more wireless communication devices or to set up an emergency connection.

16. A network controller device for providing access to a wireless first responder network, the network controller device comprising an apparatus of claim 1.

17. An anchor node for providing wireless connectivity to wireless communication devices in a wireless first responder network, the anchor node comprising an apparatus of claim 11.

18. The anchor node of claim 17, comprising an unmanned robot device that can be operated remotely or can operate autonomously and serves as a cellular access device or a relay device.

19. (canceled)

20. The system of claim 24, configured as a standalone end-to-end wireless system and further comprising connectivity to a backhaul network.

21. A method of establishing a wireless first responder network, wherein the method comprises:
receiving information about dimensions of a target wireless coverage area;
determining a number of anchor nodes and their position in the target wireless coverage area to provide wireless coverage in the target wireless coverage area based on capabilities of the anchor nodes; and
providing the determined position and a network configuration information to the determined anchor nodes.

22. A method of supporting establishment of a wireless first responder network, wherein the method comprises:
attaching to the wireless first responder network;
providing wireless connectivity to wireless communication devices at an anchor node of the first responder network;
receiving from a network controller device of the first responder network at least one of a position information of the anchor node, information about a target geographical area, a communication characteristic information of objects located in the target geographical area and a network configuration information;
enabling wireless communication between the anchor node and one or more wireless communication devices based on the at least one of the position information, the information about the target geographical area; the communication characteristic information and the network configuration information; and
using the anchor node for enabling the one or more wireless communication devices to communicate with a core network of the first responder network or for determining position information of the one or more wireless communication devices.

23. A computer program product comprising code means for producing the steps of claim 21 when run on a computer device.

24. A wireless communication system comprising:
a network controller device operating a core network, the network controller device providing access to a wireless first responder network, the network controller device comprising:
an apparatus for establishing a wireless first responder network, wherein the apparatus is configured to:
receive information about a dimension of a target wireless coverage area;
determine a number of anchor nodes and their position in the target wireless coverage area to provide wireless coverage in the target wireless coverage area based on the capabilities of the anchor nodes; and
provide the determined position and a network configuration information to the determined anchor nodes;
an anchor node connected to the network controller device, the anchor node providing wireless connectivity to wireless communication devices in a wireless first responder network, the anchor node comprising the apparatus wherein the apparatus is configured to determine a need for additional anchor nodes based on the received network configuration information and a capacity of the anchor nodes; and
one or more wireless communication devices.
